(19) United States
(12) Patent Application Publication
(10) Pub. No.: US 2010/0094726 A1
(43) Pub. Date: Apr. 15, 2010

(54) Digital Media Purchasing as an Extension of Previewing

(75) Inventor: Apaar Tuli, Helsinki (FI)

Correspondence Address: DITTHAVONG MORI & STEINER, P.C., 918 Prince Street, Alexandria, VA, 22314, US

(73) Assignee: NOKIA CORPORATION, Espoo (FI)

(21) Appl. No.: 12/249,122

(22) Filed: Oct. 10, 2008

(51) Int. Cl. G06Q 30/00

(52) U.S. Cl. 705/27

(57) ABSTRACT

Content purchases or purchases of other items may be automatically completed upon expiration of a preview period. Thus, no user interaction may be needed to transition from a preview phase to purchasing. Upon expiration of the preview period, a user may be given an opportunity to undo the transaction. The availability of the undo option may last a predefined amount of time.

Some aspects of the invention generally relate to the purchasing of media content in connection with previewing the content.

### BACKGROUND

On-line shopping often requires a user to go through many phases or pages of information and data entry before the purchase can be completed. For example, users may be required to view a product page, add the product to a shopping cart, subsequently check out by entering billing information and finally confirm submission of the order. The multiple steps may require significant investments of time and attention, especially for regular shoppers of a site or those who enjoy making impulse purchases.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to some aspects, a content item may be purchased automatically during or after previewing the content item without additional user interaction. In particular, when a user initiates a preview of a content item, the content item may be automatically purchased once a predetermined amount of time has expired. This allows a user to purchase an item without having to interact with the system after initiating a preview of the desired item. A timer may be used to determine the end of a preview or decision period and to trigger the automatic purchase of the content item upon expiration of the preview or decision period.

In another aspect, a user may be allowed to cancel or undo a purchase a predefined amount of time, e.g., an undo period, after the purchase has been made. At the expiration of the undo period, the purchase may be finalized and the cancellation option may no longer be available to the user. The undo period may begin after the expiration of the preview period.

According to yet another aspect, notifications may be provided to the user to indicate that a purchase will be made in a specified amount of time unless the user selects an option indicating that he or she does not wish to purchase the content. In one example, a semi-transparent information banner may overlay a portion of the content being previewed. Additionally or alternatively, a playback timeline may include information such as a current purchase or preview phase (e.g., preview, decision, undo) and an elapsed amount of time.

### BRIEF DESCRIPTION OF THE DRAWINGS

Certain embodiments are illustrated by way of example and not limited in the accompanying figures in which like reference numerals indicate similar elements and in which:

FIG. 1 illustrates a block diagram of an example communication network in which one or more embodiments may be implemented.

FIG. 2 illustrates a block diagram of an example communication device according to one or more aspects described herein.

FIG. 3 illustrates a flow diagram of a method for previewing and purchasing content according to one or more aspects described herein.

FIG. 4 illustrates a purchase timeline according to aspects described herein.

FIGS. 5A-5E illustrate example interfaces for previewing and purchasing content items according to one or more aspects described herein.

FIG. 6 illustrates a block diagram of an apparatus for automated purchasing of content items in a preview environment according to aspects described herein.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

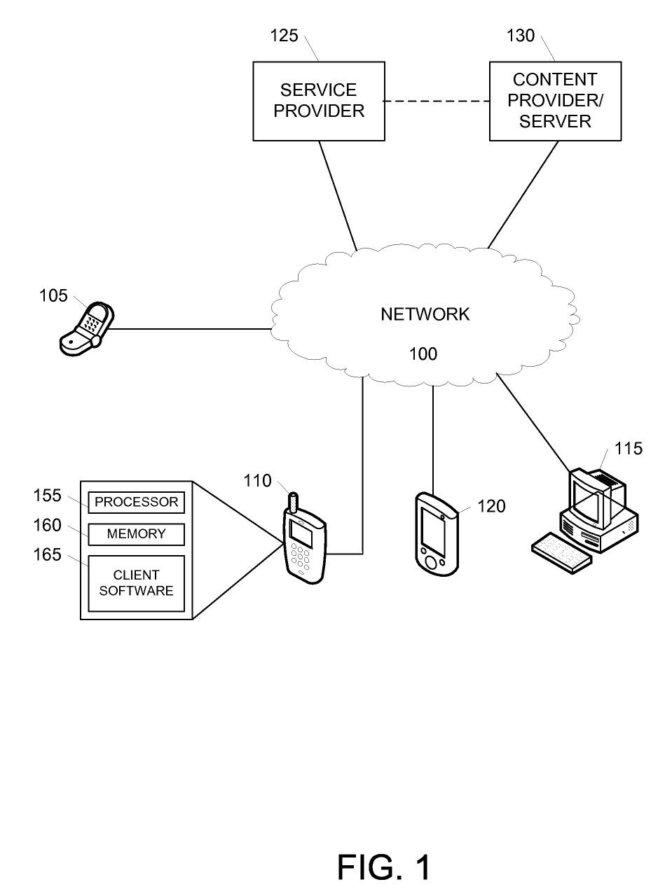

FIG. 1 illustrates an example communication network through which various inventive principles may be practiced. A number of computers and devices including mobile communication device 105, mobile phone 110, personal digital assistant (PDA) or mobile computer 120, personal computer (PC) 115, service provider 125 and content provider 130 may communicate with one another and with other devices through network 100. Network 100 may include wired and wireless connections and network elements, and connections over the network may include permanent or temporary connections. Communication through network 100 is not limited to the illustrated devices and may include additional mobile or fixed devices such as a video storage system, an audio/video player, a digital camera/camcorder, a positioning device such as a GPS (Global Positioning System) device or satellite, a television, an audio/video player, a radio broadcasting receiver, a set-top box (STB), a digital video recorder, remote control devices and any combination thereof.

Although shown as a single network in FIG. 1 for simplicity, network 100 may include multiple networks that are interlinked so as to provide internetworked communications. Such networks may include one or more private or public packet-switched networks (e.g., the Internet), one or more private or public circuit-switched networks (e.g., a public switched telephone network), a cellular network configured to facilitate communications to and from mobile communication devices 105 and 110 (e.g., through use of base stations, mobile switching centers, etc.), a short or medium range wireless communication connection (e.g., Bluetooth®, ultra wideband (UWB), infrared, WiBree, wireless local area network (WLAN) according to one or more versions of Institute of Electrical and Electronics Engineers (IEEE) standard no. 802.11), or a high-speed wireless data network such as Evolution-Data Optimized (EV-DO) networks, Universal Mobile Telecommunications System (UMTS) networks, Long Term Evolution (LTE) networks or Enhanced Data rates for GSM Evolution (EDGE) networks. Devices 105-120 may use various communication protocols such as Internet Protocol (IP), Transmission Control Protocol (TCP), Simple Mail Transfer Protocol (SMTP) among others known in the art. Various messaging services such as Short Messaging Service (SMS) and/or Multimedia Message Service (MMS) may also be included.

Devices 105-120 may be configured to interact with each other or other devices, such as content server 130 or service provider 125. In one example, mobile device 110 may include client software 165 that is configured to coordinate the transmission and reception of information to and from content provider/server 130. In one arrangement, client software 165 may include application or server specific protocols for requesting and receiving content from content server 130. For example, client software 165 may comprise a Web browser or mobile variants thereof and content provider/server 130 may comprise a web server. Billing services (not shown) may also be included to charge access or data fees for services rendered. In one arrangement where service provider 125 provides cellular network access (e.g., a wireless service provider), client software 165 may include instructions for access and communication through the cellular network. Client software 165 may be stored in computer-readable memory 160 such as read only or random access memory in device 110 and may include instructions that cause one or more components (e.g., processor 155, a transceiver, and a display) of device 110 to perform various functions and methods including those described herein.

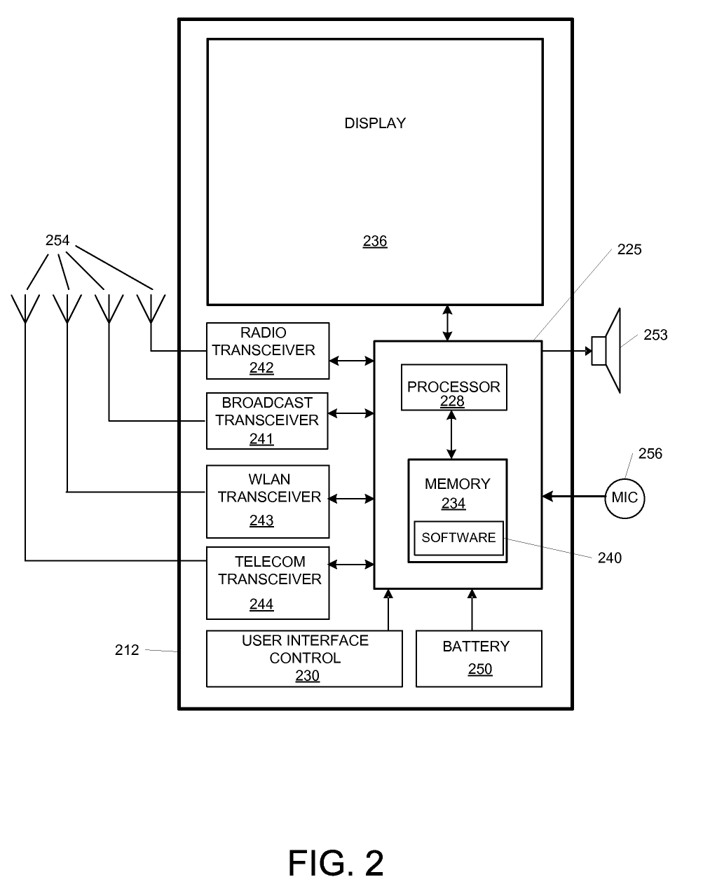

FIG. 2 illustrates an example computing device such as mobile device 212 that may be used in network 100 of FIG. 1. Mobile device 212 may include a controller 225 connected to a user interface control 230, display 236 and other elements as illustrated. Controller 225 may include one or more processors 228 and memory 234 storing software 240. Mobile device 212 may also include a battery 250, speaker 252 and antenna 254. User interface control 230 may include controllers or adapters configured to receive input from or provide output to a keypad, touch screen, voice interface (e.g. via microphone 256), function keys, joystick, data glove, mouse and the like.

Computer executable instructions and data used by processor 228 and other components of mobile device 212 may be stored in a storage facility such as memory 234. Memory 234 may comprise any type or combination of read only memory (ROM) modules or random access memory (RAM) modules, including both volatile and nonvolatile memory such as disks. Software 240 may be stored within memory 234 to provide instructions to processor 228 such that when the instructions are executed, processor 228, mobile device 212 and/or other components of mobile device 212 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including electrically erasable programmable read-only memory (EEPROM), flash memory or other memory technology, CD-ROM, DVD or other optical disk storage, magnetic cassettes, magnetic tape, magnetic storage and the like.

Mobile device 212 or its various components may be configured to receive, decode and process various types of transmissions including digital broadband broadcast transmissions that are based, for example, on the Digital Video Broadcast (DVB) standard, such as DVB-H, DVB-H+, or DVB-MHP, through a specific broadcast transceiver 241. Other digital transmission formats may alternatively be used to deliver content and information of availability of supplemental services. Additionally or alternatively, mobile device 212 may be configured to receive, decode and process transmissions through FM/AM Radio transceiver 242, wireless local area network (WLAN) transceiver 243, and telecommunications transceiver 244. Transceivers 241, 242, 243 and 244 may, alternatively, include individual transmitter and receiver components.

Although the above description of FIG. 2 generally relates to a mobile device, other devices or systems may include the same or similar components and perform the same or similar functions and methods. For example, a stationary computer such as PC 115 (FIG. 1) may include the components described above and may be configured to perform the same or similar functions as mobile device 212 and its components.

According to some aspects, a device such as devices 105-120 of FIG. 1 or mobile device 212 of FIG. 2 may be configured to purchase and download media content. For example, mobile phones and other computing devices may have the capability to access network sites that provide music, television shows, movies, text, ring tones, other audio, video or text and the like for purchase and subsequent download. However, as with many purchases, users typically want the opportunity to preview content that they are considering buying. In many instances, a preview function and a purchase option are separate aspects of a site and require multiple user interactions to go between previewing and purchasing content.

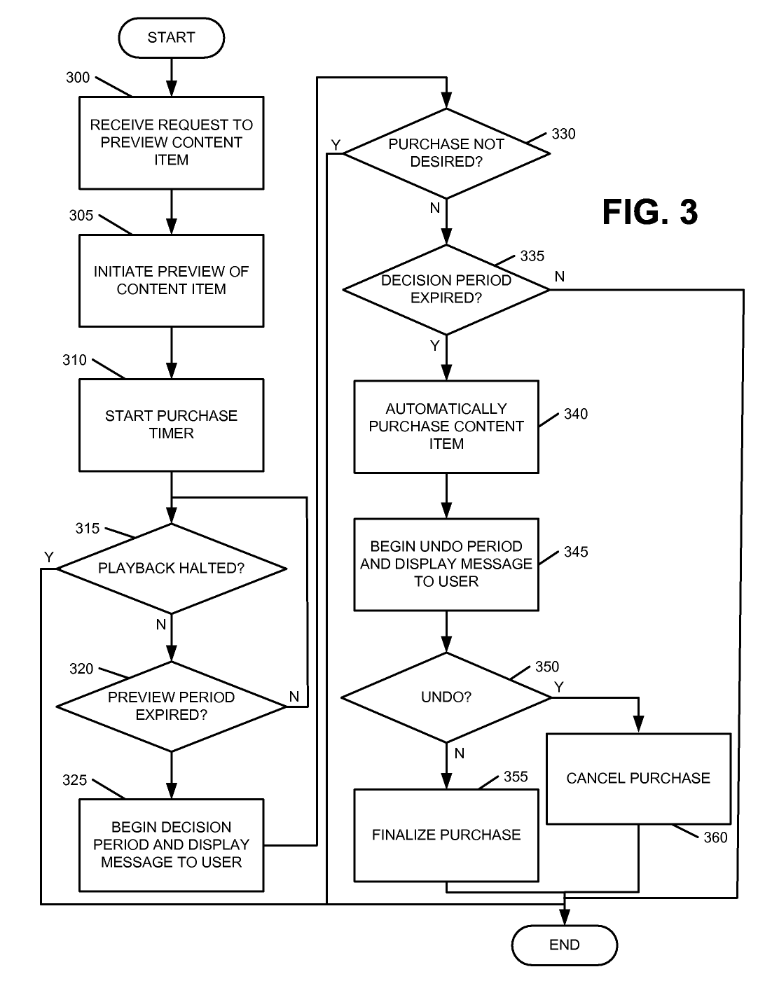

FIG. 3 is a flowchart illustrating a method for previewing and purchasing content without additional user interaction beyond initiation of the preview. In step 300, for instance, a content server may receive a request to preview a content item. The request may correspond to user input on a remote user device or may comprise an automated preview request upon, for example, a user accessing a content site. Specifically, some sites may automatically initiate a preview upon a user navigating to or requesting those sites. In other instances, the user may be required to manually select a preview option. In step 305, the content server may initiate a preview of the requested content in response to the request. Simultaneously or substantially simultaneously therewith, the server may start a purchase timer in step 310. In one arrangement, the purchase timer is synchronized with a playback timer or timeline of the content preview. In step 315, the content server may determine whether the preview or play of the content item has been halted. If so, the automatic purchase process may end. If however, preview or play of the content has not been stopped, the content server may determine whether a preview period of the purchase timer has expired in step 320. For example, a user may be allowed to preview content for 15 seconds before being asked to make a decision. If the preview period has expired, the content server may, in step 325, proceed to a decision period where the user is given a predefined amount of time to decide whether to purchase the content. During the decision period, the server may determine in step 330 whether the user has elected not to purchase the content. A user may indicate an unwillingness to purchase the content by selecting a pause or stop button that would halt the preview of the content item, for example.

If the user has not indicated that he or she does not want to purchase the content, the server may then determine whether the decision period has expired in step 335. If the decision period has expired, the content server may automatically process the purchase of the content item for the user in step 340 without user interaction. For example, the server may automatically process payment of the content item without user input or confirmation. In one or more arrangements, a user's payment information may be stored on the server or the server may generate a bill that is later sent to the user. In one example, the purchase may be automatically charged to the user's mobile telephone account. Thus, a user may essentially purchase a content item through a single interaction of initiating a preview of the content item.

Upon expiration of the decision period, the server may initiate an undo period in step 345 where a user is permitted to cancel or undo the purchase. In step 350, the server may determine whether the user has elected to cancel the purchase. If not, the purchase is finalized in step 355 without requiring user interaction. Finalizing a purchase may include generating and transmitting a receipt, initiating or providing an option to download the content to the user's device, displaying a purchase completion message and the like. If, however, the user elects to cancel the purchase within the undo period, the server may stop or cancel the purchase in step 360. For example, a server may cancel the purchase by stopping the transaction with a payment processing entity or crediting a payment amount back to the user's account. Additionally, if the undo option is selected, the content preview may also be halted. The undo provisions are optional and might only be included in some embodiments.

According to one or more configurations, the preview period and the decision period may be included as one period such that at the end of the single combined period, the content is automatically purchased. Additionally or alternatively, the methods and features described may be conducted on the client side. Thus, the client may be responsible and configured to render content, determine whether a preview period has expired and facilitate automatic purchase of the content item. In one example, the client may be authorized and configured to perform such functions using trusted software or certificates from a content server.

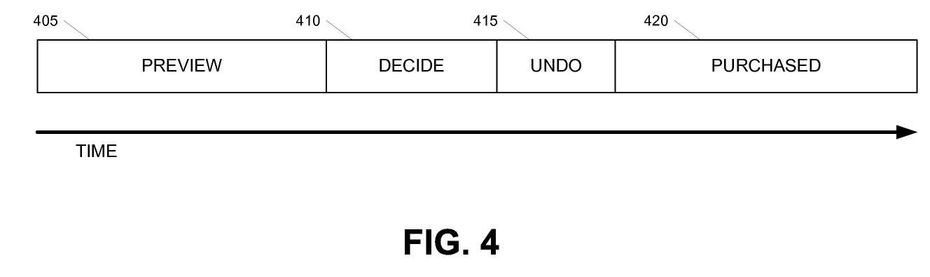

FIG. 4 illustrates a purchase timeline including a preview period 405, a decision period 410, an undo or cancel period 415 and a purchase complete period 420. As described, during the preview period 405, a user may watch, listen to or read a portion of a content item for a predefined amount of time. For example, the preview period may last 10 seconds, 30 seconds, 10% of the entire content item or the like. In some configurations, the preview period may be set to end at a critical, exciting, suspenseful or climactic portion of the content to pique the viewer's interest and entice him or her to purchase. Upon expiration of preview period 405, decision period 410 begins. A user must, during decision period 410, decide whether or not to purchase the content item. In one or more configurations, the content item may continue to play during decision period 410. If the user does not stop the preview or otherwise indicate that they do not want to purchase the content, the purchase timeline transitions into undo period 415 at the expiration of decision period 410. During this transition, purchase of the content may be processed. Undo period 415 user may give the user a specified amount of time in which to cancel the purchase if he or she made a mistake or has changed his or her mind. Once undo period 415 expires, the content purchase is finalized in purchase complete period 420. As with decision period 410, the content may continue to play during undo period 415 and purchase complete period 420. Alternatively, the preview may only last as long as the preview period 405 and decision period 410 combined. Optionally, a purchase complete period 420 might not be defined in a purchase timeline. That is, upon expiration of undo period 415, a purchase timeline may end.

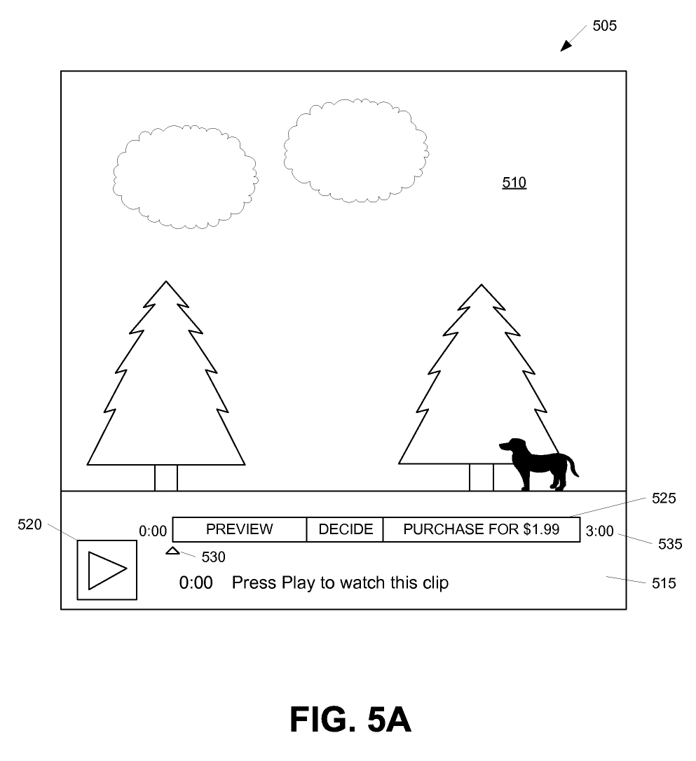

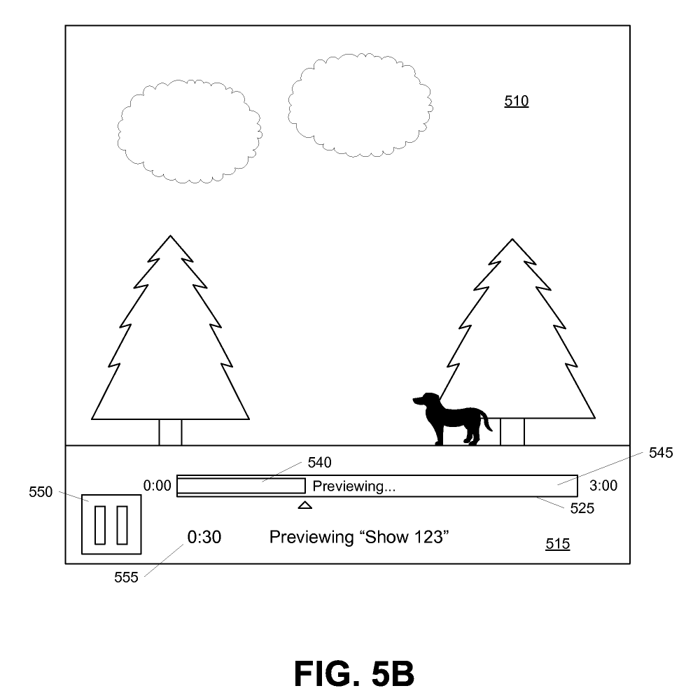

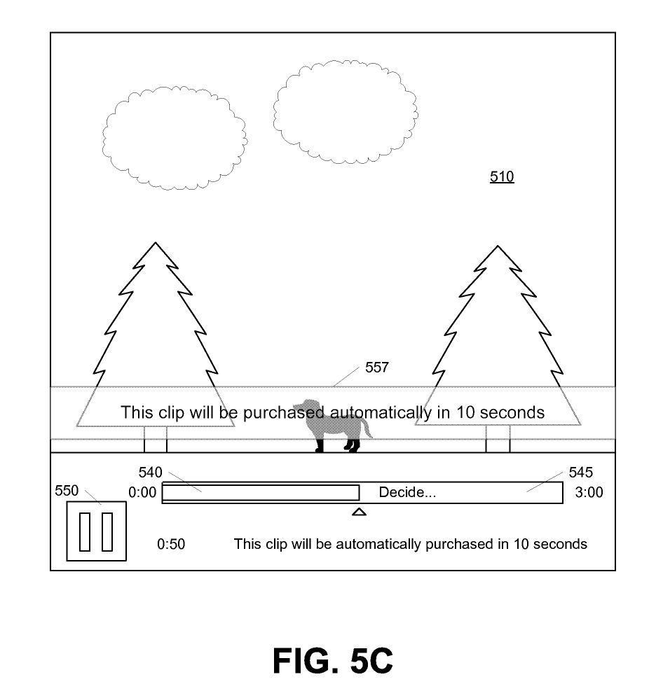

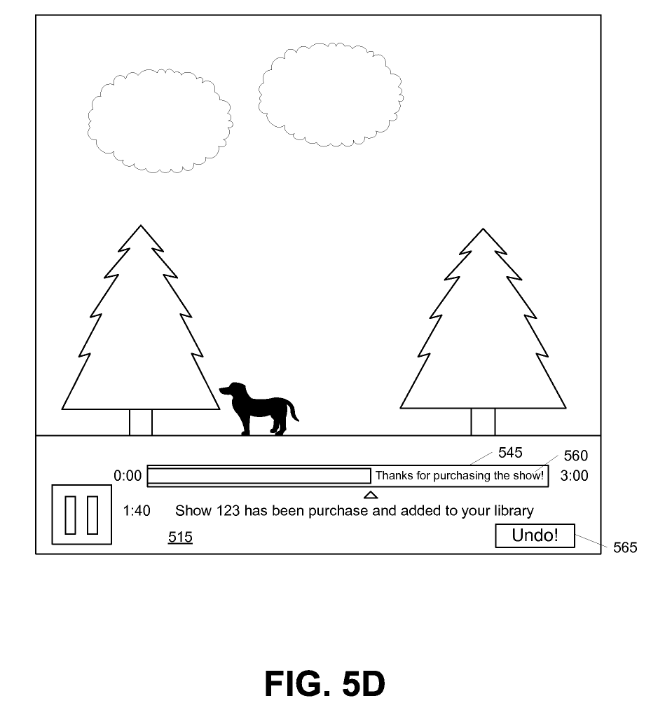

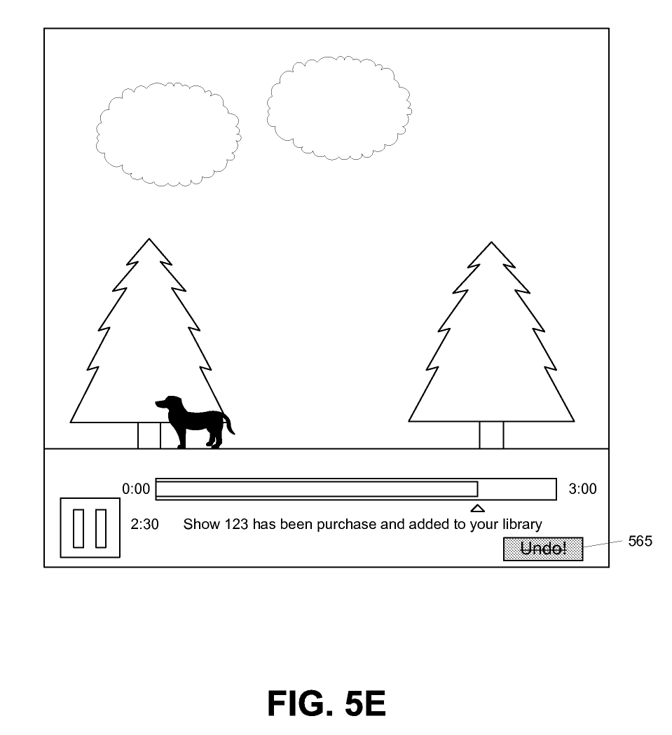

FIGS. 5A-5E illustrate a series of displays in which a video content item is previewed and purchase is effected through aspects described herein. In FIG. 5A, for example, interface 505 includes a content display portion 510 and a control panel 515. Control panel 515 includes a play button 520 and a purchase timeline 525. A user may initiate a preview of the content by selecting play button 520. Progress indicator 530 may then travel along purchase timeline 525 to identify a current purchase period and a current location in the content preview. Additionally or alternatively, control panel 515 may indicate the length 535 of the content item or portion of the content item that is to be played. In one or more configurations, prior to playback of the content, purchase timeline 525 may include information such as the purchase or preview periods associated with timeline 525 as well as a price to purchase the content (e.g., $1.99).

Upon selection of play button 520, the content item may begin playing in display portion 510. Timeline 525 may change in appearance upon playback of the content item. In particular, referring to FIG. 5B, instead of displaying each of the various purchase periods in timeline 525, timeline 525 may change to include a played portion indicator 540 and an unplayed portion indicator 545. The unplayed portion indicator 545 may include information indicating the current purchase period. For example, in FIG. 5B, unplayed portion indicator 545 specifies that the user is currently in the preview period. Play button 520 (FIG. 5A) may also change into a pause or stop button 550 upon initiating playback of the content item. Additionally, control panel 515 may include an indication 555 of the amount of time elapsed.

After the preview period expires, timeline 525 may transition into a decision period. As shown in FIG. 5C, unplayed portion indicator 545 indicates that the user is now in the decision period. The appearance of the played portion indicator 540 may change to reflect the current period. For example, a color of the played portion indicator 540 may change between different periods. Additionally or alternatively, pause button 550 may change in appearance to highlight or emphasize the action corresponding to selection of button 550. That is, the appearance of pause button 550 may change to alert the user to the fact that they should stop the playback if they do not want to purchase the content. In one example, the pause symbol may change colors and/or button 550 may glow. Content display portion 510 may further include an informational overlay 557 to notify a user of an amount of time remaining before the content item is automatically purchased. Information overlay 557 may have a level of transparency to allow visibility of the underlying content.

FIG. 5D illustrates an interface after the decision period has expired and the content item has been purchased. A purchase completion or thank you message 560 may be displayed in unplayed portion indicator 545. After the expiration of the decision period, the user may be given an undo period. Accordingly, an undo option 565 may be provided in control panel 515. If the user selects to undo the purchase, the purchase may be cancelled or credited back to the user's account. If, on the other hand, the user does not undo the purchase and the undo period expires, the availability of undo option 565 may be removed. For example, in FIG. 5E, undo option 565 is grayed and crossed out to indicate that the user can no longer undo the transaction.

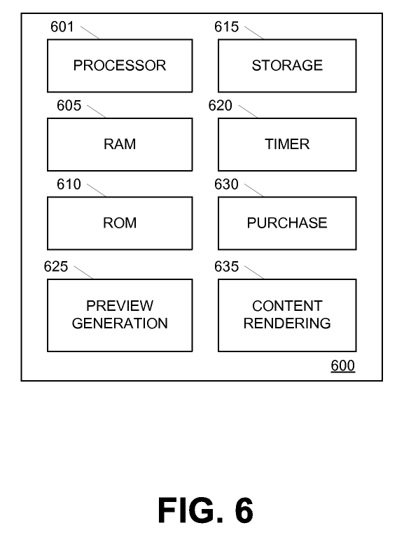

FIG. 6 illustrates a block diagram of a previewing and purchasing system comprising components configured to perform various aspects of the purchase method described. Content server 600 may include a processor 601 configured to execute various instructions, RAM 605, ROM 610, storage module 615, timer module 620, preview generation module 625, purchase module 630 and content rendering module 635. Storage module 615 may be configured to store content items, user accounts and profiles, payment information, purchase histories and the like. Timer module 620, on the other hand, may be configured to determine the beginning and end of various phases in the purchase timeline. For example, the timer module 620 may be responsible for determining whether a preview period has ended. Purchase module 630 may be configured to execute or process purchase transactions. Purchase module 630 may, for example, request payment from a credit card company, a merchant network, a telecommunications network or a payment services system. Preview generation module 625 may be used and configured to create previews of content items stored in storage module 615. In one example, preview generation module 625 may create a 30 second preview clip from a 25 minute television show by extracting the first 30 seconds of the television show. In another example, the preview generation module 625 may select three random 10 second portions of a song to create a preview. Once the preview is generated, content rendering module 635 may be used to play the content. If the user wishes to purchase content, purchase module 630 is configured to process payment and complete the purchase transaction. The modules of FIG. 6 may comprise software, hardware, firmware or combinations thereof. Other modules may also be used or substituted. The preview and purchasing system may be a server side device such as a content server or a client side device such as a mobile communication device. In some arrangements, the preview and purchasing system may be a distributed system. For example, a content server may be configured to provide previews while the client device may be configured to automate and facilitate the purchasing of a desired item.

The purchasing features described herein may be used for a variety of items and is not limited to media content. For example, aspects may be used for purchase of physical items such as furniture, electronics, toys and the like. In one example, a preview for furniture or toys may include a video showcasing features of the product. Upon expiration of a preview period, the furniture or toy may be automatically purchased.

It should be understood that any of the method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any of various types of well-known computing structures including but not limited to one or more microprocessors, special-purpose computer chips, field-programmable gate arrays (FPGAS), controllers, application-specific integrated circuits (ASICS), combinations of hardware/firmware/software, or other special or general-purpose processing circuitry.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions or other data stored in a read only memory (ROM). In some such embodiments, the ROM stores programming instructions that cause the IC to perform operations according to one or more of the methods described herein. In at least some other embodiments, one or more the methods described herein are hardwired into an IC. In other words, the IC is in such cases an application specific integrated circuit (ASIC) having gates and other logic dedicated to the calculations and other operations described herein. In still other embodiments, the IC may perform some operations based on execution of programming instructions read from ROM or RAM, with other operations hardwired into gates and other logic of IC. Further, the IC may output image data to a display buffer.

Although specific examples of carrying out the invention have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

We claim:

1. A method comprising:
providing a preview of an item;
determining whether a preview time period has expired, wherein at least the preview of the item is played during the preview time period and wherein the preview time period begins upon a start of the preview; and
in response to determining that the preview time period has expired, automatically initiating a purchase of the item.

2. The method of claim 1, wherein the item is a media content item.

3. The method of claim 2, wherein the media content item comprises at least one of video, audio and text.

4. The method of claim 1, wherein the purchase of the item is automatically initiated by a client device.

5. The method of claim 1, wherein the preview of the item is provided in response to a request received at a mobile device.

6. The method of claim 1, further comprising generating a display comprising an amount of time until the item is automatically purchased.

7. The method of claim 3, wherein the amount of time is displayed overlaying the preview of the item.

8. The method of claim 1, further comprising initiating an undo period upon expiration of the preview time period, wherein a purchase cancellation option is provided during the undo period.

9. The method of claim 8, further comprising removing the purchase cancellation option determining that the undo period has expired.

10. The method of claim 1, further comprising:
receiving a command to stop the preview; and
in response to the command, discontinuing an automatic purchase process.

11. An apparatus comprising:
a processor; and
memory storing computer readable instructions that, when executed, cause the apparatus to perform:
providing a preview of an item;
determining whether a preview time period has expired, wherein at least the preview of the item is played during the preview time period and wherein the preview time period begins upon a start of the preview; and
in response to determining that the preview time period has expired, automatically initiating a purchase of the item.

12. The apparatus of claim 11, wherein the first time period includes a preview period and a decision period occurring after the expiration of the preview period, wherein the preview and decision periods each include a halt preview option and wherein the memory further comprises instructions for changing an appearance of the halt preview option when transitioning from the preview period to the decision period.

13. The apparatus of claim 11, wherein the apparatus is a server side device.

14. The apparatus of claim 11, the memory further comprising instructions for displaying an amount of time until the item is automatically purchased.

15. The apparatus of claim 14, wherein the amount of time is displayed overlaying the preview of the item.

16. The apparatus of claim 11, the memory further comprising instructions for initiating an undo period upon expiration of the first time period, wherein a purchase cancellation option is provided during the undo period.

17. The apparatus of claim 16, the memory further comprising instructions for removing the purchase cancellation option determining that the undo period has expired.

18. The apparatus of claim 11, wherein the item is a media content item.

19. The apparatus of claim 18, wherein the media content item comprises at least one of video, audio and text.

20. The apparatus of claim 11, wherein the apparatus is a client device.

21. The apparatus of claim 11, wherein the preview of the item is provided in response to a request received at a mobile device.

22. One or more computer readable media storing computer readable instructions that, when executed, cause a processor to perform a method comprising:
providing a preview of an item;
determining whether a preview time period has expired, wherein at least the preview of the item is played during the preview time period and wherein the preview time period begins upon a start of the preview; and
in response to determining that the preview time period has expired, automatically initiating a purchase of the item.

23. The one or more computer readable media of claim 22, wherein the first time period includes a preview period and a decision period occurring after the expiration of the preview period, wherein the preview and decision periods each include a halt preview option and wherein the one or more computer readable media further comprises instructions for changing an appearance of the halt preview option when transitioning from the preview period to the decision period.

24. The one or more computer readable media of claim 22, further comprising instructions for displaying an amount of time until the item is automatically purchased, wherein the amount of time is displayed overlaying the preview of the item.

25. The one or more computer readable media of claim 22, further comprising instructions for initiating an undo period upon expiration of the first time period, wherein a purchase cancellation option is provided during the undo period.

26. The one or more computer readable media of claim 25, further comprising instructions for removing the purchase cancellation option determining that the undo period has expired.
